(19) United States
(12) Patent Application Publication
(10) Pub. No.: US 2004/0100660 A1
(43) Pub. Date: May 27, 2004

(54) Image reading apparatus

(75) Inventors: Tetsuya Yoshioka, Suita-shi (JP); Tatsuo Noda, Nishinomiya-shi (JP); Hiroyuki Takaishi, Amagasaki-shi (JP); Kiyoshi Hori, Kobe-shi (JP)

Correspondence Address: CASELLA & HESPOS, 274 MADISON AVENUE, NEW YORK, NY, 10016

(73) Assignee: Kyocera Mita Corporation, Osaka-shi (JP)

(21) Appl. No.: 10/705,367

(22) Filed: Nov. 10, 2003

(30) Foreign Application Priority Data
Nov. 25, 2002 (JP) 2002-340377

(51) Int. Cl. G06F 15/00; H04N 1/00

(52) U.S. Cl. 358/402; 358/1.15

(57) ABSTRACT

A digital complex machine has a scanner controller which is operative to serially send plural image data corresponding to plural document sets read by a scanning section to a recipient designated by a user on a serial transmission designating screen displayed on a touch panel portion, if a serial transmission mode of serially sending plural image data corresponding to plural document sets is designated.

### BACKGROUND OF THE INVENTION

1. Field of the Invention

The present invention relates to an image reading apparatus so configured as to render image data transmittable to another device via a predetermined network, and more particularly to a network-type digital complex machine integrally loaded with various functions such as a scanner, a facsimile machine, a printer, and a copier.

2. Description of the Related Art

In recent years, network-type digital complex machines integrally loaded with various functions such as a scanner, a facsimile machine, a printer, and a copier have been developed. For instance, Japanese Unexamined Patent Publication No. 2002-77504 discloses a digital complex machine equipped with a scanning function of reading image data from a document with use of a built-in scanner so that the read data is transmittable to a desired computer or the like via a network.

In case of using the scanner in the above digital complex machine, first, a user identification screen is displayed for identifying a user. In response to identification of the user on the user identification screen, the digital complex machine specifies the Internet Protocol (IP) address of the user's computer by referring to the address book in which respective IP addresses of the registered user's computers are stored. Thus, the IP address of the computer of the user who uses the digital complex machine is specified, so that the image data read by the scanner is directly transmittable to the IP address of the specified computer, namely, to the user's computer or that a notification is transmittable to the user's computer to notify the user of completion of the image data transmission.

The conventional digital complex machine is so configured that the user is required to implement various designating operations such as identification of the user, designation of a recipient, and setting on transmission conditions each time image data of a document or documents is read before depressing the start button to execute transmission of the image data. With such a configuration, even if image data is to be transmitted to a single recipient under the same transmission conditions in a serial job operation of serially sending plural image data corresponding to plural document sets, a user is required to implement various designating operations such as identification of the user, designation of the recipient, and setting on the transmission conditions each time image data is sent. This makes the designating operation in the serial job operation cumbersome, and hampers the operability of the user in use of the digital complex machine.

### SUMMARY OF THE INVENTION

In view of the above, an object of the present invention is to provide an image reading apparatus that enables to provide a user with improved operability in a serial job operation of serially sending plural image data corresponding to plural document sets.

An image reading apparatus according to an aspect of the present invention is so configured as to render image data transmittable to a device via a predetermined network. The image reading apparatus comprises: reading means for reading an image of a document to generate image data corresponding. to the document image; recipient designating means for designating a recipient to which the image data read by the reading means is sent via the network in response to a manipulation by a user; and transmitting means for transmitting the image data read by the reading means to the recipient designated by the recipient designating means, wherein the transmitting means serially sends plural image data corresponding to plural document sets read by the reading means to the recipient designated by the recipient designating means in a serial transmission mode of serially sending plural image data corresponding to plural document sets.

In the image reading apparatus, after the recipient to which image data is to be sent is designated in response to the manipulation by the user, the image data corresponding to the document image read by the reading means is generated, and the generated image data is sent to the designated recipient in the serial transmission mode of serially sending plural image data corresponding to plural document sets read by the reading means. The image reading and the image data transmission are cyclically repeated for a certain number of times with respect to the plural document sets to serially send the plural image data corresponding to the plural document sets read by the reading means to the designated recipient. With this arrangement, the user is allowed to serially send the plural image data corresponding to the plural document sets to the recipient with one time designation of the recipient. This is advantageous in improving the operability of the user in a serial job operation of serially transmitting plural image data corresponding to plural document sets.

These and other objects, features and advantages of the present invention will become more apparent upon reading of the following detailed description along with the accompanying drawings.

### BRIEF DESCRIPTION OF THE DRAWINGS

FIG. 1 is a block diagram showing a configuration of a network system in which a digital complex machine according to an embodiment of the present invention is used.

FIG. 2 is a schematic side view primarily showing a mechanical construction of the digital complex machine shown in FIG. 1.

FIG. 3 is a block diagram primarily showing an electrical configuration of the digital complex machine shown in FIG. 1.

FIG. 4 is a flowchart for explaining an example of a scanning operation with use of the digital complex machine shown in FIG. 1.

FIG. 5 is an illustration of a screen image showing an example of a scanner initialization screen.

FIG. 6 is an illustration of a screen image showing an example of a mode initialization screen.

FIG. 7 is an illustration of a screen image showing an example of a scanner function designation screen.

FIG. 8 is an illustration of a screen image showing an example of a user identification screen.

FIG. 9 is an illustration of a screen image showing an example of a serial transmission setting screen.

FIG. 10 is an illustration of a screen image showing an example of an individual transmission setting screen.

### DETAILED DESCRIFNON OF THE PREFERRED EMBODIMENTS

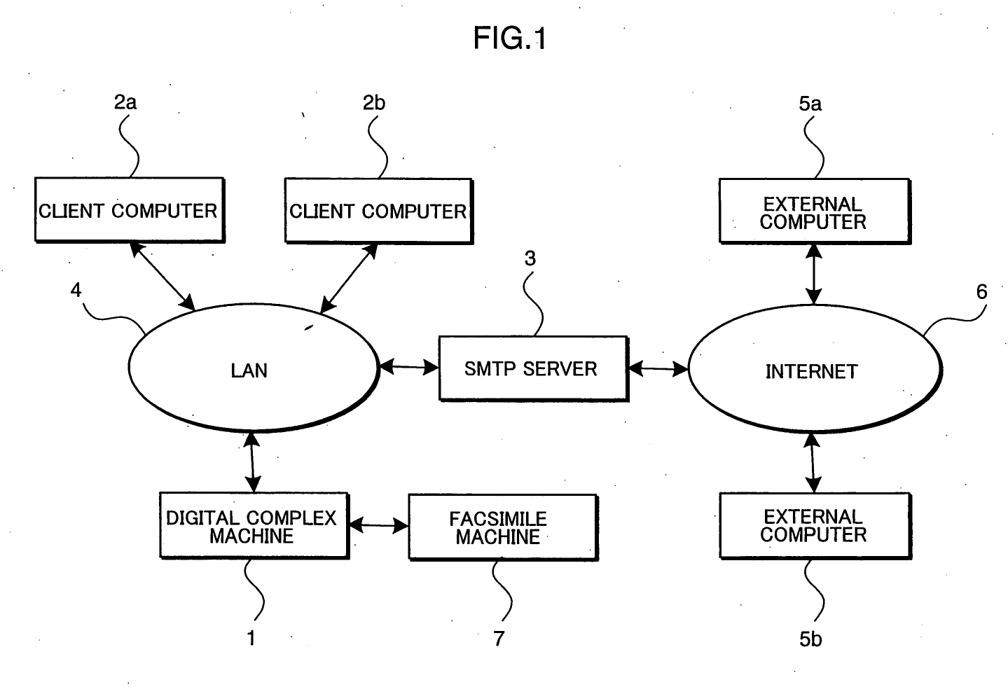

In the following, a digital complex machine according to an embodiment of the present invention is described by way of an exemplified image reading apparatus according to the present invention referring to the accompanying drawings. FIG. 1 is a block diagram showing a configuration of a network system in which the digital complex machine according to the embodiment of the present invention is used.

The network system shown in FIG. 1 includes the digital complex machine 1, personal computers 2a, 2b used by users (hereinafter, called as “client computers”), a simple mail transfer protocol (SMTP) server 3, and external personal computers (hereinafter, called as “external computers”) 5a, 5b. The digital complex machine 1, the client computers 2a, 2b, and the SMTP server 3 are communicatively connected with each other via a local area network (LAN) 4, an example of the network, so that various data are communicable among them. The SMTP server 3 and the external computers 5a, 5b are communicatively connected with each other via the Internet 6, an example of the network, so that various data including an electronic mail are communicable among them. The digital complex machine 1 is communicatively connected to a facsimile machine 7 which is installed outside of the user's workplace where the digital complex machine 1 is installed, via a telephone line, an example of the network.

For instance, in case that the network system having the above configuration is used in an office, the network in the office corresponds to the LAN 4, the equipment used by the users (office workers and the like staff in the office) corresponds to the digital complex machine 1 and the client computers 2a, 2b, and the equipment which is installed in a branch office or its equivalent and is used by the users in the branch office (office workers and the like staff in the branch office) corresponds to the external computers 5a, 5b, and the facsimile machine 7.

Various alterations are applicable to the configuration of the network system. As an altered form, the number of the client computers, external computers, and facsimile machines communicatively connectable to the digital complex machine 1 via the LAN 4 or the like may be changed. As a further altered form, a gateway, a router, or the like may be provided in addition to the SMTP server 3 as a device for connecting the LAN 4 with the Internet 6. As yet another altered form, various servers such as a document administration server may be additionally provided.

The digital complex machine 1 is a multi-functional digitally-operated copying machine equipped with various functions such as a scanner, a facsimile machine, a printer, and a copier. The digital complex machine 1 enables a user to implement various functions by optionally combining the aforementioned functions with each other. For instance, PC transmission function, e-mail transmission function, and FAX transmission function are some of the functions implemented as the scanner.

PC transmission function is a function of directly sending image data read from a document from the digital complex machine 1 to the client computer 2a (2b or the like) via the LAN 4. E-mail transmission function is a function of sending image data read from a document as a file attached to an electronic mail by directly sending the image data as the attached file from the digital complex machine 1 to the SMTP server 3 via the LAN 4, as well as sending the electronic mail from the SMTP server 3 to the external computer 5a (5b or the like) via the Internet 6. FAX transmission function is a function of directly sending image data read from a document from the digital complex machine 1 to the facsimile machine 7 or its equivalent via the telephone line.

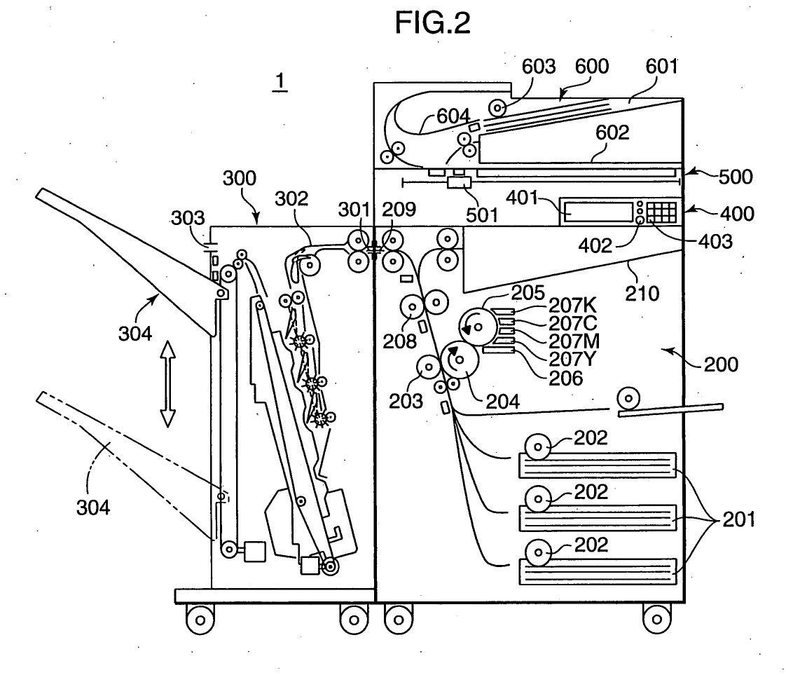

FIG. 2 is a schematic side view primarily showing a mechanical construction of the digital complex machine shown in FIG. 1. The digital complex machine 1 has a main body 200, a sheet post-processing section 300 provided on the left side of the main body 200, an operating section 400 on which a user enters various operation commands or the like, a document reading section 500 provided at an upper part of the main body 200, and a document feeding section 600 provided above the document reading section 500.

The operating section 400 includes a touch panel 401, a start key 402, and a ten key 403. The touch panel 401 is adapted to display various operation screens, as well as various operation buttons. A user is allowed to enter various operation commands by touching the operation buttons displayed on the touch panel 401. The start key 402 is adapted for allowing a user to enter a print execution command or the like. With the ten key 403, a user is allowed to enter the number of copies to be printed or the like.

The document feeding section 600 includes a document setting portion 601, a document discharging portion 602, a document feed roller 603, and a document transporting portion 604. The document reading section 500 includes a scanner 501. The document feed roller 603 is adapted to feed documents placed on the document setting portion 601 one by one. The document transporting portion 604 is adapted to transport the documents fed by the document feed roller 603 one by one onto a specified position on the scanner 501, which, in turn, reads the document images one by one. The documents after the image reading are discharged onto the document discharging portion 602.

The main body 200 includes sheet cassettes 201, sheet feed rollers 202, a transfer roller 203, an intermediate transfer roller 204, a photosensitive drum 205, an exposing device 206, developers 207Y, 207M, 207C, 207K for developing color images of yellow, magenta, cyan, and black, respectively, a fixing roller 208, a sheet discharge port 209, and a sheet discharge tray 210.

The photosensitive drum 205 has its surface uniformly charged by a charger (not shown) while being rotated in the direction shown by the arrow in FIG. 1. The exposing device 206 converts a demodulated signal generated based on the image data of a document read by the document reading section 500 into a laser beam for output so as to form electrostatic latent images of respective colors on the surface of the photosensitive drum 205. The developers 207Y, 207M, 207C, 207K are adapted to develop the latent images to toner images of respective colors by supplying developing agents of respective colors onto the photosensitive drum 205. The toner images of respective colors are then transferred from the photosensitive drum 205 to the intermediate transfer roller 204 to form the toner images of respective colors on the intermediate transfer roller 204.

As timed with the above operations, a copy sheet is dispensed by the sheet feed roller 202 from one of the sheet cassettes 201 each storing a stack of copy sheets, and is fed to a specified position in a clearance defined by the transfer roller 203 and the intermediate transfer roller 204. Then, the toner images of respective colors formed on the intermediate transfer roller 204 are transferred onto the copy sheet carried to the specified position between the transfer roller 203 and the intermediate transfer roller 204. The fixing roller 208 fixes the transferred toner images of respective colors onto the copy sheet by heating the transferred toner images. Thereafter, the copy sheet is transported to the sheet post-processing section 300 through the sheet discharge port 209 of the main body 200. The copy sheet after the image fixation may be discharged onto the sheet discharge tray 210 according to needs.

The sheet post-processing section 300 includes a sheet inlet 301, a sheet transporter 302, a sheet outlet 303, and a stacker tray 304. The sheet transporter 302 transports the copy sheets discharged through the sheet discharge port 209 and transported into the sheet post-processing section 300 through the inlet 301 one after another, and discharges the copy sheets through the outlet 303 onto the stacker tray 304. The stacker tray 304 is movable up and down in the directions of the hollow arrows shown in FIG. 1 depending on the number of sheets to be stacked onto the stacker tray 304 through the outlet 303.

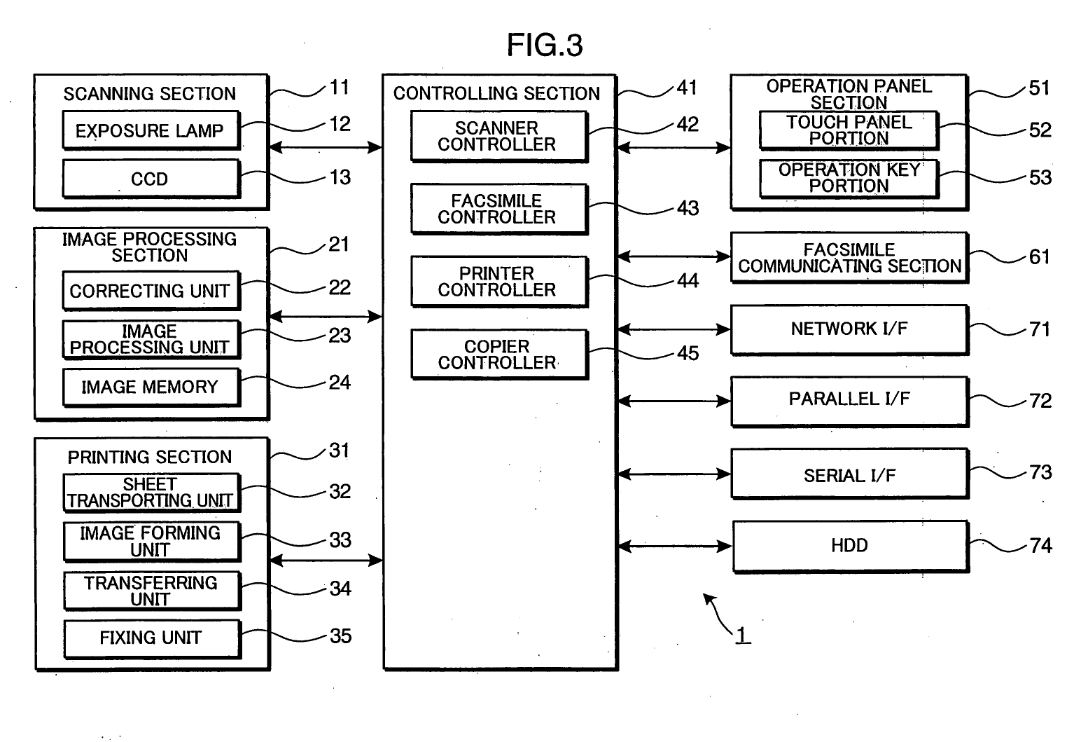

FIG. 3 is a block diagram primarily showing an electrical configuration of the digital complex machine shown in FIG. 1. The digital complex machine 1 includes a scanning section 11, an image processing section 21, a printing section 31, a controlling section 41, an operation panel section 51, a facsimile communicating section 61, a network interface (I/F) 71, a parallel interface (I/F) 72, a serial interface (I/F) 73, and a hard disk drive (HDD) 74.

The scanning section 11, the image processing section 21, the controlling section 41, the operation panel section 51, and the network I/F 71 correspond to the operating section 400, the document reading section 500, and the document feeding section 600 shown in FIG. 2. A scanning function is realized by the elements 11, 21, 41, 51, and 71. The scanning section 11, the image processing section 21, the printing section 31, the controlling section 41, the operation panel section 51, and the facsimile communicating section 61 correspond to the main body 200, the operating section 400, the document reading section 500, and the document feeding section 600 shown in FIG. 2. A facsimile communicating function is realized by the elements 11, 21, 31, 41, 51, and 61. The image processing section 21, the printing section 31, the controlling section 41, the operation panel section 51, the network I/F 71, and the parallel I/F 72 correspond to the main body 200 and the operating section 400 shown in FIG. 2. A printing function is realized by the elements 21, 31, 41, 51, 71, and 72. The scanning section 11 the image processing section 21, the printing section 31, the controlling section 41, the operation panel section 51, and the network I/F 71 correspond to the main body 200, the sheet post-processing section 300, the operating section 400, the document reading section 500, and the document feeding section 600 shown in FIG. 2. A copying function is realized by the elements 11, 21, 31, 41, 51, and 71.

The operation panel section 51 includes a touch panel portion 52 comprised of the touch panel 401 shown in FIG. 2, and an operation key portion 53 comprised of the start key 402 and the ten key 403 shown in FIG. 2. A user is allowed to manipulate the digital complex machine 1 by way of the operation panel section 51 to implement the scanning function, facsimile communicating function, printing function, or copying function, and to issue an operation command or the like to the controlling section 41. The touch panel portion 52 comprises a touch panel unit including a touch panel and a liquid crystal display (LCD). The touch panel portion 52 is adapted to display various operation screens, e.g., information relating to identification of the user, designation of a recipient, and setting on transmission conditions in implementing the scanning function. The touch panel portion 52 also displays operation buttons. A user is allowed to enter various operation commands by touching the relevant operation button displayed on the touch panel portion 52. The operation key portion 53 is used for a user to enter a print execution command, a scan start command, or the like.

The controlling section 41 includes a scanner controller 42, a facsimile controller 43, a printer controller 44, and a copier controller 45. The controlling section 41 includes a microcomputer and a dedicated hardware circuit to control an overall operation of the digital complex machine. The scanner controller 42 controls operations of the relevant elements for realizing the scanning function. The facsimile controller 43 controls operations of the relevant elements for realizing the facsimile communicating function. The printer controller 44 controls operations of the relevant elements for realizing the printing function. The copier controller 45 controls operations of the relevant elements for realizing the copying function.

The scanning section 11 includes an exposure lamp 12 and a charge coupled device (CCD) 13 which constitute the scanner 501 shown in FIG. 2. The scanning section 11 is constructed in such a manner that a document placed on the document setting portion 601 is irradiated with light from the exposure lamp 12, the light reflected on the document is received on the CCD 13 to read a light image of the document, and image data corresponding to the read image is outputted to the image processing section 21.

The image processing section 21 includes a correcting unit 22, an image processing unit 23, and an image memory 24. The image processing section 21 is so configured that the read image data is corrected and processed by the correcting unit 22 and the image processing unit 23, respectively, according to needs, and that the processed image data is stored in the image memory 24 for outputting to the printing section 31, the facsimile communicating section 61, the network I/F 71,. or the like. The correcting unit 22 performs a predetermined correction such as level correction and gamma correction with respect to the read image data. The image processing unit 23 performs various image processings such as compression/decompression and enlargement/reduction of image data.

The printing section 31 includes: a sheet transporting unit 32 comprised of the sheet cassettes 201 and the sheet feed rollers 202 shown in FIG. 2; an image forming unit 33 comprised of the intermediate transfer roller 204, the photosensitive drum 205, the exposing device 206, and the developers 207Y, 207M, 207C, 207K shown in FIG. 2; a transferring unit 34 comprised of the transfer roller 203 shown in FIG. 2; and a fixing unit 35 comprised of the fixing roller 208 shown in FIG. 2. The printing section 31 is so configured that an image is printed on a copy sheet based on image data such as document data read by the scanning section 11, printable data sent from the client computer 2a (2b or the like) via the network I/F 71, facsimile data sent from the facsimile machine 7 or the like with use -of the facsimile communicating section 61. Specifically, the sheet transporting unit 32 is adapted to transport a copy sheet to the image forming unit 33, the image forming unit 33 is adapted to form a toner image corresponding to the image data, the transferring unit 34 is adapted to transfer the toner image onto the copy sheet, and the fixing unit 35 is adapted to fix the toner image onto the copy sheet.

The facsimile communicating section 61 includes an encoding/decoding unit (not shown), a modulating/demodulating unit (not shown), and a network control. unit (NCU) (not shown). The facsimile communicating section 61 is adapted to send image data of a document read by the scanning section 11 to the facsimile machine 7 or the like via the telephone line, and to receive image data sent from the facsimile machine 7 or the like. The encoding/decoding unit compresses and encodes the image data to be sent to the facsimile machine 7 or the like; and decompresses and decodes the image data sent from the facsimile machine 7 or the like. The modulating/demodulating unit modulates the compressed and encoded image data to an audio signal, and demodulates the received signal (audio signal) to the image data. The NCU controls connection with the facsimile machine 7 or the like, which is a recipient and sender of the image data, via the telephone line.

For example, a network interface (10/100Base-Tx) is used as the network I/F 71 to control data communication among the client computers 2a, 2b, and the SMTP sever 3 which are communicatively connected with each other via the LAN 4. For instance, with use of the network I/F 71, image data of a document read by the scanning section 11 is sent to the client computer 2a (2b or the like). A high-speed interactive parallel interface based on IEEE 1284 is used as an example of the parallel I/F 72 to receive data such as printable data from an external device or the like according to parallel transmission in which data is transmitted in the unit of bits with use of signal lines. A serial interface according to RS-232C is used as the serial I/F 73, for instance, to receive various data from the external device or the like according to serial transmission in which data is transmitted bit by bit with use of a single signal line.

The HDD 74 is adapted to store image data read by the scanning section 11, an output format which has been set in advance with respect to the image data, etc. The image data stored in the HDD 74 is not only used within the digital complex machine 1, but also used for allowing a user to confirm on the client computer 2a (2b or the like) via the network I/F 71 or may be transferred to a predetermined folder in the client computer 2a (2b or the like) according to needs.

In this embodiment, the scanning section 11 and the scanner controller 42 correspond to an example of the reading means of the present invention; the scanner controller 42 and the operation panel section 51 correspond to an example of the recipient designating means, setting means, initializing means, intermediate setting means, and user identifying means of the present invention; the scanner controller 42 and the network I/F 71 correspond to an example of the transmitting means of the present invention; and the touch panel portion 52 corresponds to an example of the operating means and switching means of the present invention.

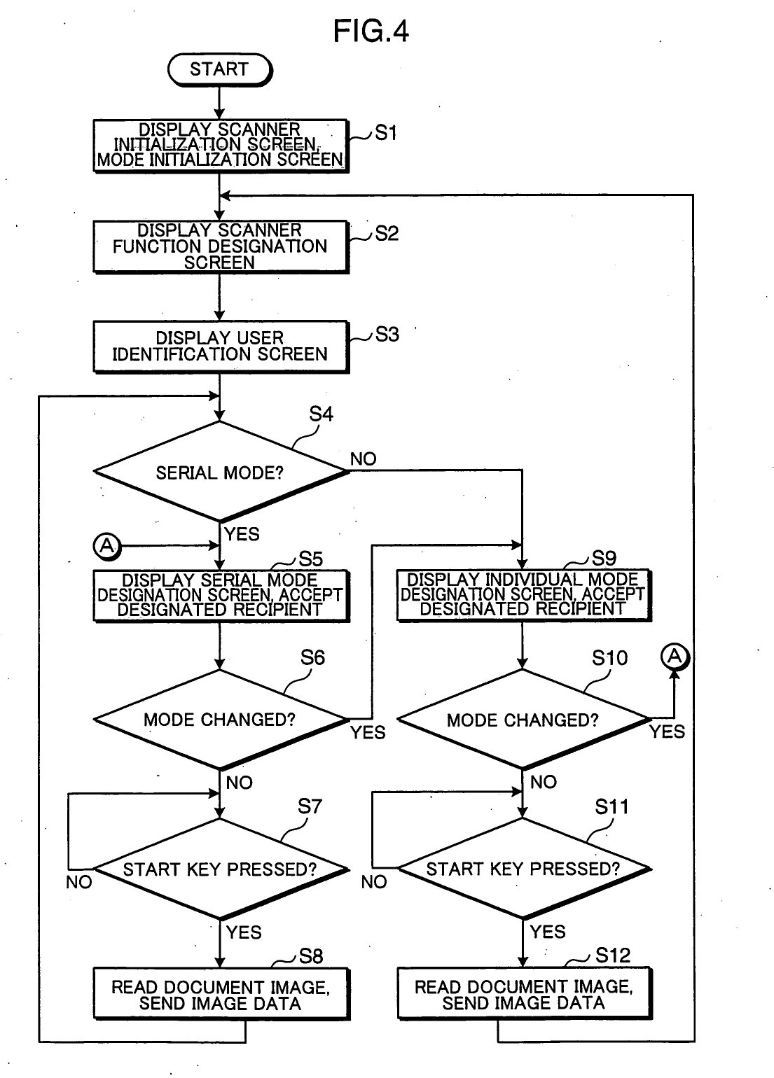

Next, a scanning process of the digital complex machine having the above arrangement is described referring to FIG. 4. FIG. 4 is a flowchart for explaining an example of the scanning process executed by the digital complex machine shown in FIG. 3.

In FIG. 4, when a user places a document or documents on the document setting portion 601 and enters a command of displaying a scanner initialization screen by manipulating on the touch panel portion 52, the scanner controller 42 causes the touch panel portion 52 to display the scanner initialization screen and a mode initialization screen successively (Step S1). When the scanner initialization screen is displayed, the user is allowed to selectively designate either one of the serial transmission mode and the individual transmission mode. When the user selects a transmission mode by way of the scanner initialization screen and the mode initialization screen, the designated mode is set as an initial transmission mode.

In the present specification and claims, “serial transmission mode” is a mode of serially transmitting plural image data read from plural document sets, and “individual transmission mode” is a mode of individually transmitting single image data read from a single document set. “Single document set” represents a group of documents to be transmitted by one transmission process, and may be one or more documents. “Plural document sets” represents a plurality of single document sets to be transmitted by a plurality of transmission processes. “Single image data” represents image data read from a single document set. “Plural image data” represents a plurality of single image data, and corresponds to image data read from plural document sets.

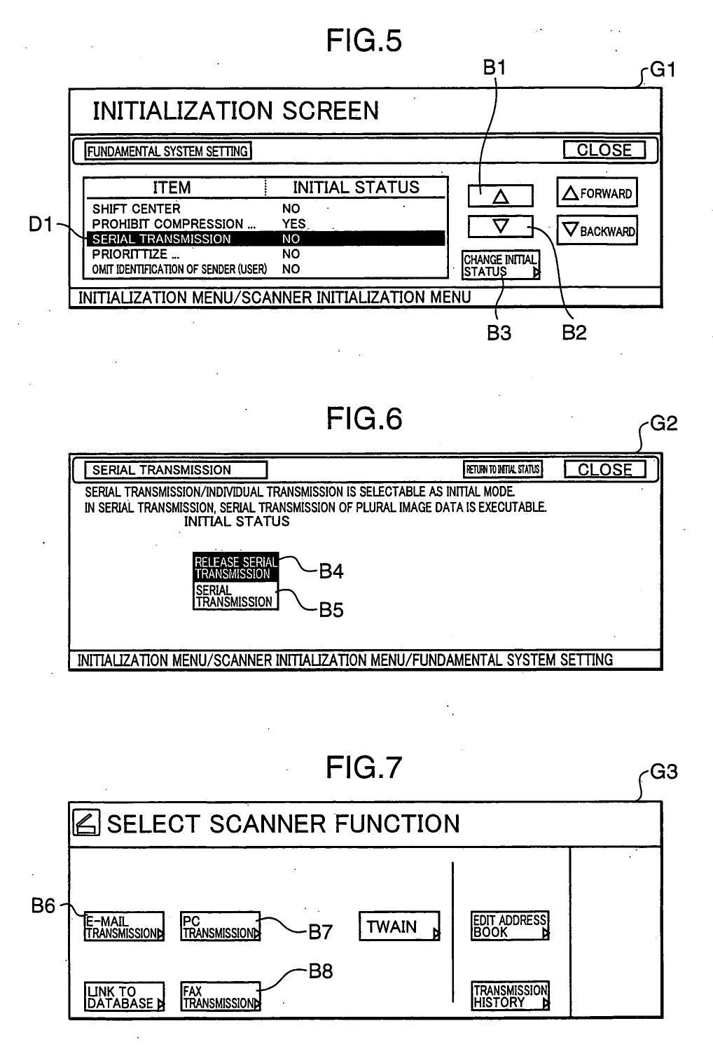

FIG. 5.is an illustration of a screen image showing an example of the scanner initialization screen. As shown in FIG. 5, the scanner initialization screen G1 is displayed on the touch panel portion 52. Presence or absence of designation of the serial transmission mode is displayed on the scanner initialization screen G1 as a fundamental system setting. When a user manipulates an UP button B1 or a DOWN button B2 to superpose an inverted portion Dl over the column indicating designation/non-designation of the serial transmission mode, and then touches a CHANGE INITIAL STATUS button B3, the scanner initialization screen is changed to the mode initialization screen.

FIG. 6 is an illustration of a screen image showing an example of the. mode initialization screen. On the mode initialization screen G2 shown in FIG. 6, displayed are a RELEASE SERIAL TRANSMISSION button B4 for allowing a user to release designation of the serial transmission mode (namely, to designate individual transmission mode), and a SERIAL TRANSMISSION button B5 for allowing the user to designate the serial transmission mode. In other words, the user can select either one of the serial transmission mode and the individual transmission mode by touching the button B4 or the button B5, so that the transmission mode in correspondence to the selected button (in the example of FIG. 6, the individual transmission mode is selected) is set as the initial transmission mode.

In this way, since either one of the serial transmission mode and the individual transmission mode is selected as the initial transmission mode in response to designation of the mode by the user, the user can send a document image or images in the designated transmission mode merely with one time designation of the transmission mode of frequent use. This arrangement is advantageous in improving the operability of the user in a serial job operation of serially transmitting plural image data corresponding to plural document sets.

Referring back to FIG. 4, when the user enters a command of displaying a scanner function designating screen by manipulating on the touch panel portion 52, the scanner controller 42 causes the touch panel portion 52 to display the scanner function designation screen, and renders a scanning function designated by the user operative (Step S2). On the scanner function designation screen, the user is allowed to select a function from PC transmission function, e-mail transmission function, and FAX transmission function.

FIG. 7 is an illustration of a screen image showing an example of the scanner function designation screen. As shown in FIG. 7, the scanner function designation screen G3 is displayed on the touch panel portion 52. On the scanner function designation screen G3, displayed are an E-MAIL TRANSMISSION button B6 for allowing a user to designate the e-mail transmission function, a PC TRANSMISSION button B7 for allowing the user to designate the PC transmission function, and a FAX TRANSMISSION button B8 for allowing the user to designate the FAX transmission function. In other words, the user can select a desired scanning function from the e-mail transmission function, the PC transmission function, and the FAX transmission function with one time touching of one of the buttons B6, B7 and B8.

Referring back to FIG. 4, in Step S3, the scanner controller 42 causes the touch panel portion 52 to display a user identification screen to identify the user of the digital complex machine 1 in response to a user's manipulation on the user identification screen.

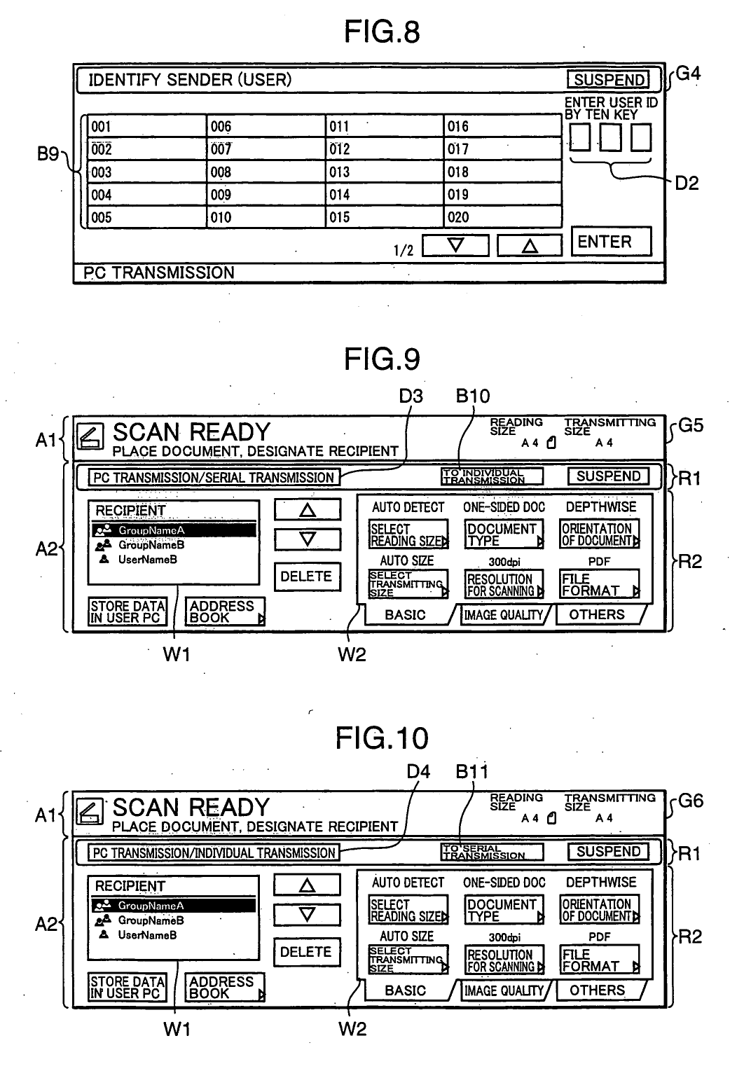

FIG. 8 is an illustration of a screen image showing an example of the user identification screen. As shown in FIG. 8, a sender (user) identification screen G4 is displayed as the user identification screen on the touch panel portion 52. On the sender (user) identification screen G4, displayed are a plurality of user identification (ID) buttons B9 for allowing each of the registered users to select the user identification number allocated to them in advance. In the example shown in FIG. 8, the digits “001”, “002” . . . , and “020” displayed in the respective user ID buttons B9 are user identification numbers. For instance, if a user allocated with the user identification number 003 touches the user ID button B9 of the digits “003”, the user is authenticated as the registered user. Alternatively, the user is authenticated as the registered user by entering the user identification number on a ten key enter section D2 displayed on the right side of the sender (user) identification screen G4.

The user identification numbers are stored in a memory (not shown) or its equivalent in the controlling section 41 in correlation to the IP addresses or its equivalent for identifying the client computers of the users allocated with the respective user identification numbers. The digital complex machine 1 can specify the IP address or its equivalent of the client computer of the user, namely, identify the sender of the image data read by a below-mentioned document scanning process, based on the user identification number of the user. With this arrangement, in the case where PC transmission function is designated, and the user wishes to receive the image data read by the scanning section 11 in his or her own computer, the image data is directly transmitted to the IP address of the designated computer, i.e., to the user's own computer. Further, in the case where e-mail transmission function, PC transmission function, or FAX transmission function is designated, and the user wishes to send the image data to another user, a notification notifying the user of completion of the image data transmission is transmitted to the user's own computer.

Referring back to FIG. 4, in Step S4, the scanner controller 42 judges whether the serial transmission mode is set as the transmission mode. If it is judged that the serial transmission mode is set (YES in Step S4), the routine goes to Step S5, whereas if it is judged that the individual transmission mode is set (NO in Step S4), the routine goes to Step S9.

In Step S5, the scanner controller 42 causes the touch panel portion 52 to display a serial transmission setting screen. On the serial transmission setting screen, a user is allowed to designate various items for transmission such as a recipient in the serial transmission mode, so that the scanner controller 42 may accept the designation by the user such as a recipient.

FIG. 9 is an illustration of a screen image showing an example of the serial transmission setting screen. As shown in FIG. 9, a serial transmission setting screen G5 is displayed on the touch panel portion 52. The serial transmission setting screen G5 consists of a status display area Al for displaying a current status of the digital complex machine 1, and a transmission designating area A2 which serves as an operation region for allowing a user to designate various items for transmission. The transmission designating area A2 consists of a title region R1 for displaying the currently operative function or the like, and a general item designating region R2 for allowing a user to designate general items for transmission other than the serial transmission mode and the individual transmission mode.

On the general item designating region R2, displayed are a recipient designating window W1 for allowing a user to designate a recipient or an addressee, as well as a general item designating window W2 with which a user is allowed to designate various parameters such as document size for data reading, sheet size for data transmission, document type, image resolution for scanning, orientation of the document, and file format. With this arrangement, the user can designate the recipient of the data in the serial transmission mode with use of the recipient designating window W1, or designate the document size and the like in the serial transmission mode with use of the general item designating window W2.

Referring back to FIG. 4, in Step S6, the scanner controller 42 judges whether the user changed the transmission mode on the touch panel portion 52. If it is judged that the transmission mode is changed to the individual transmission mode (YES in Step S6), the routine proceeds to Step S9. On the other hand, if it is judged that the transmission mode is not changed to the individual transmission mode (NO in Step S6), the routine proceeds to Step S7.

Referring back to FIG. 9, a function display section D3 for displaying the currently operative function is displayed on the left side of the title region R1 on the serial transmission setting screen G5, and a transmission mode changeover button B10, an example of the switching means, is displayed on the right side of the title region R1. In the example of FIG. 9, PC transmission function and serial transmission mode are set as currently operative functions. Accordingly, a character string “PC TRANSMISSION/SERIAL TRANSMISSION” indicative of these functions are displayed on the function display section D3, and a character string “TO INDIVIDUAL TRANSMISSION” indicating the user that the transmission mode is changeable to the individual transmission mode is displayed on the transmission mode changeover button B10. With this arrangement, a user can change over the transmission mode from the serial transmission mode to the individual transmission mode by touching the transmission mode changeover button B10.

In this embodiment, the transmission mode changeover button B10 is provided in the title region R1, which is an operation region other than the general item designating region R2 serving as a region for allowing a user to designate other general items for transmission within the transmission designating area A2. With this arrangement, the user can recognize at a first glance the transmission mode changeover button B10 within the serial transmission setting screen G5. This arrangement is advantageous in improving the operability of the user in a serial job operation of serially sending plural image data corresponding to plural document sets. The same advantage is obtained with respect to a transmission mode changeover button B11 (see FIG. 10), which will be described later.

Referring back to FIG. 4, in the case where the transmission mode is not changed (NO in step S6), then, in Step S7, the scanner controller 42 judges whether the user depressed the start key 402 of the operation key portion 53. If it is judged that the start key 402 is depressed (YES in Step S7), the routine goes to Step S8, whereas if it is judged that the start key 402 is not depressed (NO in Step S7), the routine repeats the process in Step S7.

In Step S8, the scanner controller 42 causes the image processing section 21 to generate single image data corresponding to a single document set by reading the single document set, and sends the single image data to the recipient designated in Step S5.

Specifically, in the case where PC transmission function is designated in Step S2, the scanner controller 42 directly sends the image data read by the scanning section 11 from the network I/F 71 via the LAN 4 to the recipient such as the client computer 2a (2b or the like). In the case where e-mail transmission function is designated, the scanner controller 42 directly sends the image data read by the scanning section 11 as a file attached to an electronic mail from the network I/F 71 via the LAN 4 to the SMTP server, while sending the attached file as image data to the recipient such as the external computer 5a (5b or the like) via the Internet 6. In the case where FAX transmission function is designated, the scanner controller 42 directly sends the image data read by the scanning section 11 from the facsimile communicating section 61 via the telephone line to the recipient such as the facsimile machine 7. In the case where a transmission function other than the above transmission functions is designated, the image data read by the scanning section 11 is sent to the recipient designated by the user depending on the designated transmission function.

After the process in Step S8 is completed, the routine returns to Step S4 to cyclically repeat the processes thereafter. In repeating the processes, since the serial transmission mode has been set as the transmission mode, the serial transmission setting screen G5 shown in FIG. 9 is displayed again (YES in Step S4, and the process in Step S5), so that the user can continue to send image data corresponding to a next document set by merely placing the next document set on the document setting portion 601 and depressing the start key 402 (YES in Step S7, and the process in Step S8).

With the above arrangement, the user can serially send image data corresponding to plural document sets by placing the plural document sets one after another on the document setting portion 601 and pressing the start key 402 with one time operation with respect to the user identification and designation of the recipient. This arrangement is advantageous in improving the operability of the user in a serial job operation of serially sending plural image data corresponding to plural document sets.

On the other hand, if the individual transmission mode is set (NO in Step S4), in Step S9, the scanner controller 42 causes the touch panel portion 52 to display an individual transmission setting screen on which a user is allowed to designate various items for transmission such as a recipient in the individual transmission mode, so that the scanner controller 42 may accept the designation by the user such as a recipient.

FIG. 10 is an illustration of a screen image showing an example of the individual transmission setting screen. As shown in FIG. 10, the individual transmission setting screen G6 is displayed on the touch panel portion 52. As with the case of the serial transmission setting screen G5, the individual transmission setting screen G6 consists of a status display area Al and a transmission designating area A2. The transmission designating area A2 consists of a title region R1 and a general item designating region R2. On the general item designating region R2, a recipient designating window W1 and a general item designating window W2 are displayed. With this arrangement, a user can designate a recipient of image data in the individual transmission mode with use of the recipient designating window W1, and designate various parameters such as the document size in the individual transmission mode with use of the general item designating window.W2.

Referring back to FIG. 4, in Step S10, the scanner controller 42 judges whether the user changed the transmission mode on the touch panel portion 52. If it is judged that the transmission mode is changed to the serial transmission mode (YES in Step S10), the routine proceeds to Step S5, whereas if it is judged that the transmission mode is not changed (NO in Step S10), the routine proceeds to Step S11.

Referring back to FIG. 10, a function display section D4 for displaying a currently operative function is displayed on the left side of the title region R1 on the individual transmission setting screen G6, and the transmission mode changeover button B11, an example of the switching means, is displayed on the right side of the title region R1. In the example of FIG. 10, PC transmission function and the individual transmission mode are set. Accordingly, a character string “PC TRANSMISSION/INDIVIDUAL TRANSMISSION” indicative of these functions is displayed in the function display section D4, and a character string “TO SERIAL TRANSMISSION” indicating the user that the transmission mode is changeable to the serial transmission mode is displayed in the transmission mode changeover switch B11. With this arrangement, the user can change the transmission mode from the individual transmission mode to the serial transmission mode by touching the transmission mode changeover button B11.

In the above embodiment, since the transmission mode changeover buttons B10, B11 are displayed in the title region R1 of the serial transmission setting screen G5 and the individual transmission setting screen G6, respectively, the user. can change over the transmission mode between the serial and individual transmission modes by touching the transmission mode changeover button B10 or B11 according to needs. The arrangement in which either one of the serial transmission mode and the individual transmission mode is selectively changeable each time image data is transmitted in response to designation by a user facilitates the user to desirably designate the transmission mode at the time of data transmission.

Referring back to FIG. 4, in the case where the transmission mode is not changed (No in Step S10), similar to the process in Step S7, the scanner controller 42 judges whether the start key 402 is depressed (Step S11). If it is judged that the start key 402 is depressed (YES in Step S11), the routine goes to, similar to the process in Step S8, Step S12 where an image of a single document set placed on the document setting portion 601 is read by the scanning section 11 to generate single image data corresponding to the single document set in the image processing section 21, and the single image data is sent to the recipient designated in Step S9. Thus, the individual transmission mode is terminated.

After the process in Step S12 is completed, the routine returns to Step S2 to cyclically repeat the processes thereafter. In repeating the processes, since the scanner function designating process in Step S2 and the user identifying process in Step S3 are executed, the user can cyclically repeat the individual transmission mode by carrying out the respective processes in Steps S2 and S3.

As mentioned above, in the above embodiment, the transmission mode can be switched over between the serial transmission mode and the individual transmission mode in response to a user's designation. With this arrangement, in the case where the user wishes to send plural image data corresponding to plural document sets to the same recipient, the user can send the plural image data corresponding to the plural document sets serially by designating the serial transmission mode and with one time designation of the recipient. On the other hand, in the case where the user wishes to send single image data corresponding to a single document set individually to different recipients, the user can send the single image data corresponding to the single document set individually to a desired recipient by designating the individual transmission mode and designating the recipient with respect to each document set.

The image reading apparatus to which the present invention is applied is not specifically limited to the aforementioned digital complex machine. As far as an image reading apparatus can send image data to another device via a predetermined network, a network-type scanner, a network-type facsimile machine, or the like device may be embraced in such an image reading apparatus. Further, image data to be transmitted may be full-color, color, or monochromatic image data.

In the above embodiment, the respective operation buttons such as the transmission mode changeover buttons B10, B11 are displayed on the touch panel portion 52. Alternatively, a mechanical button such as a switch may be provided on the touch panel portion 52 in the similar manner as in the operation key portion 53.

The image reading apparatus according to an aspect of the present invention may further comprise setting means for selectively setting either one of the serial transmission mode of serially sending plural image data corresponding to plural document sets and the individual transmission mode of individually sending single image data corresponding to a single document set read by the reading means in response to a manipulation by the user, wherein the transmitting means serially sends plural image data corresponding to plural document sets read by the reading means to the recipient designated by the recipient designating means if the serial transmission mode is set by the setting means, and wherein the recipient designating means designates the recipient to which the image data is sent via the network in response to a manipulation by the user each image data read by the reading means, and the transmitting means individually sends each image data read by the reading means to the recipient designated by the recipient designating means if the individual transmission mode is set by the setting means.

In the above arrangement, upon designation of the serial transmission mode by the user, the serial transmission mode is set, and plural image data corresponding to plural document sets read by the reading means are serially sent to the designated recipient. On the other hand, upon designation of the individual transmission mode by the user, the individual transmission mode is set, and the recipient is designated in response to a manipulation by the user each time single image data corresponding to a single document set is read by the reading means to individually send said each image data to the designated recipient. In this way, the user is allowed to selectively designate the serial transmission mode or the individual transmission mode. Hence, the user is allowed to send plural image data corresponding to plural document sets serially to the same recipient by designating the serial transmission mode and with one time designation of the recipient if the plural image data corresponding to the plural document sets are sent to the same recipient, whereas the user is allowed to send single image data corresponding to a single document set individually to different recipients by designating the individual transmission mode and designating the recipient with respect to each document set if the single image data corresponding to the single document set is individually sent to the different recipients.

Preferably, the setting means may include initializing means for selectively designating either one of the serial transmission mode and the individual transmission mode in response to a manipulation by the user as an initialization item with respect to the image reading apparatus.

In the above arrangement, since either one of the serial transmission mode and the individual transmission mode is designated as an initial mode in response to a manipulation by the user, image data can be sent in the designated mode merely with one time designation of the transmission mode of frequent use. This arrangement is advantageous in improving the operability of the user in a serial job operation of serially transmitting plural image data corresponding to plural document sets.

Preferably, the setting means may include an intermediate designating means for selectively designating either one of the serial transmission mode and the individual transmission mode in response to a manipulation by the user each time the image data is sent.

In the above arrangement, since either one of the serial transmission mode and the individual transmission mode is designated in response to a manipulation by the user each time the image data is sent, the user can easily designate a desired transmission mode in sending the image data.

The image reading apparatus according to yet another aspect of the present invention may further comprise operating means including an operation region for allowing the user to enter an operation command to the image reading apparatus, wherein the setting means includes switching means for switching over the transmission mode of the image reading apparatus between the serial transmission mode and the individual transmission mode in response to a manipulation by the user, and wherein the switching means is provided in the operation area of the operating means including an operation region different from a region for designating other items for transmission.

In the above arrangement, the switching means for switching over the transmission mode between the serial transmission mode and the individual transmission mode in response to a manipulation by the user is provided in the operation region of the operating means which is different from the region for designating other items for transmission. With this arrangement, the user can recognize at a first glance the switching means in the operating means. This arrangement is advantageous in improving the operability of the user in a serial job operation of serially sending plural image data corresponding to plural document sets.

Preferably, the operating means may be adapted to display an operation screen in correspondence to the operation region, and the switching means may be adapted to display, in a title region of the operation screen, either one of the serial transmission mode and the individual transmission mode as a currently operative transmission mode.

In the above arrangement, since the currently operative transmission mode is displayed in the title region of the operation screen, the user can recognize at a first glance the currently operative transmission mode. This arrangement is advantageous in improving the operability of the user in a serial job operation of serially sending plural image data corresponding to plural document sets.

The image reading apparatus according to a further aspect of the present invention may further comprise user identifying means for identifying the user of the image reading apparatus among a plurality of registered users in response to a manipulation by the user, wherein the transmitting means sends, after identifying the user by the user identifying means, plural image data corresponding to plural document sets read by the reading means serially to the recipient designated by the recipient designating means.

In the above arrangement, after the user is identified among the plurality of registered users in response to a manipulation by the user, and the recipient to which the image data is sent is designated, plural image data corresponding to plural document sets read by the reading means are serially sent to the designated recipient in the serial transmission mode. With this arrangement, the plural image data corresponding to the plural document sets can be serially sent to the recipient with one time operation with respect to the user identification and the recipient designation. Further, various additional functions with use of information relating to the user identified by the user identifying means can be utilized. This arrangement is advantageous in improving the operability of the user in a serial job operation of serially sending plural image data corresponding to plural document sets.

This application is based on Japanese Patent Application No. 2002-340377 filed on Nov. 25, 2002, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image reading apparatus so configured as to render image data transmittable to a device via a predetermined network, comprising:
reading means for reading an image of a document to generate image data corresponding to the document image;
recipient designating means for designating a recipient to which the image data read by said reading means is sent via the network in response to a manipulation by a user; and
transmitting means for transmitting the image data read by said reading means to the recipient designated by said recipient designating means,
wherein said transmitting means serially sends plural image data corresponding to plural document sets read by said reading means to the recipient designated by said recipient designating means in a serial transmission mode of serially sending plural image data corresponding to plural document sets.

2. The image reading apparatus according to claim 1, further comprising setting means for selectively setting either one of said serial transmission mode and an individual transmission mode of individually sending single image data corresponding to a single document set in response to a manipulation by the user,
wherein said transmitting means serially sends plural image data corresponding to plural document sets read by said reading means to the recipient designated by said recipient designating means if the serial transmission mode is designated by said setting means, and
wherein said recipient designating means designates the recipient to which the image data is sent via the network in response to a manipulation by the user with respect to each image data read by said reading means, and said transmitting means individually sends said each image data read by said reading means to the recipient designated by said recipient designating means if the individual transmission mode is set by said setting means.

3. The image reading apparatus according to claim 2, wherein said setting means includes initializing means for selectively designating either one of said serial transmission mode and said individual transmission mode in response to a manipulation by the user as an initialization item with respect to the image reading apparatus.

4. The image reading apparatus according to claim 2, wherein said setting means includes an intermediate designating means for selectively designating either one of said serial transmission mode and said individual transmission mode in response to a manipulation by the user each time the image data is sent by said transmitting means.

5. The image reading apparatus according to claim 2, further comprising operating means for allowing the user to enter an operation command to the image reading apparatus,
wherein said setting means includes switching means for switching over the transmission mode of the image reading apparatus between said serial transmission mode and said individual transmission mode in response to a manipulation by the user, and
wherein said switching means is provided in an operation area of the operating means, said operation area including an operation region different from a region for designating other items for transmission.

6. The image reading apparatus according to claim 5, wherein said operating means is adapted to display an operation screen in correspondence to said operation region, and wherein said switching means is adapted to selectively display, in a title region of said operation screen, either one of said serial transmission mode and said individual transmission mode, as a currently operative transmission mode in the image reading apparatus.

7. The image reading apparatus according to claim 1, further comprising user identifying means for identifying the user of the image reading apparatus among a plurality of registered users in response to a manipulation by the user,
wherein said transmitting means sends, after identifying the user by said user identifying means, plural image data corresponding to plural document sets read by said reading means serially to the recipient designated by said recipient designating means in said serial transmission mode.

8. The image reading apparatus according to claim 1, further comprising user identifying means for identifying the user of the image reading apparatus among a plurality of registered users in response to a manipulation by the user,
wherein said recipient designating means stores information relating to said user and the recipient of the image data designated by said user in correlation to each other to allow the user to designate the recipient in correlation to the user identified by said user identifying means as the recipient of said image data.

9. The image reading apparatus according to claim 1, further comprising:
user identifying means for identifying the user of the image reading apparatus among a plurality of registered users in response to a manipulation by the user, and
transmission completion notifying means for storing information relating to said user and the recipient of the image data designated by said user in correlation to each other to send a notification, to the recipient in correlation to the user identified by said user identifying means, indicative of completion of transmission of the image data, in response to transmission of the image data by said transmitting means.
